(19) United States
(12) Patent Application Publication
(10) Pub. No.: US 2012/0014813 A1
(43) Pub. Date: Jan. 19, 2012

(54) Method and Apparatus for Solar Attic Fan with Air Flow Guide

(75) Inventor: Geoffrey Foreman, Incline Village, NV (US)

(73) Assignee: US Sunlight Inc., Reno, NV (US)

(21) Appl. No.: 13/184,418

(22) Filed: Jul. 15, 2011

Related U.S. Application Data
(60) Provisional application No. 61/364,991, filed on Jul. 16, 2010.

(51) Int. Cl. F04B 35/04; B23P 15/04

(52) U.S. Cl. 417/44.1; 29/889.4; 417/410.1

(57) ABSTRACT

A method and apparatus for solar attic fan with air flow guide have been disclosed. In one version a solar array provides energy for a fan having an air flow guide within a shroud thereby decreasing back pressure and increasing air flow.

### RELATED APPLICATION

The present Application for Patent is related to U.S. Patent Application No. 61/364,991 entitled “Method and Apparatus for Solar Attic Fan with Air Flow Guide” filed Jul. 16, 2010, pending, and is hereby incorporated herein by reference.

### FIELD OF THE INVENTION

The present invention pertains to fans. More particularly, the present invention relates to a method and apparatus for solar attic fan with an air flow guide.

### BACKGROUND OF THE INVENTION

Fans are used to move air and for many situations provide some degree of assistance in cooling humans or structures. A source of power that is becoming more favored is solar. However, due to the limited power provided by solar, traditional attic fans are not very efficient. This presents a problem.

### BRIEF DESCRIPTION OF THE DRAWINGS

The invention is illustrated by way of example and not limitation in the figures of the accompanying drawings in which:

FIG. 1 illustrates a network environment in which the method and apparatus of the invention may be controlled;

FIG. 2 is a block diagram of a computer system which some embodiments of the invention may employ parts of; and

FIGS. 3-28 illustrate various embodiments of the present invention.

### DETAILED DESCRIPTION

A method and apparatus for solar attic fan with air flow guide is disclosed. In one approach an apparatus using a tiltable and rotatable solar panel, a battery, a fan, and an airflow guide provide attic ventilation. These and other embodiments of the present invention are described in the writings and drawings herewith.

In one embodiment of the invention, when the fan is not in use, the solar panel may recharge a battery for later use. In one embodiment of the invention the solar panel output may be controlled by a computer which may be connected to a network.

In one embodiment the invention may be tailored to an attic exhaust fan.

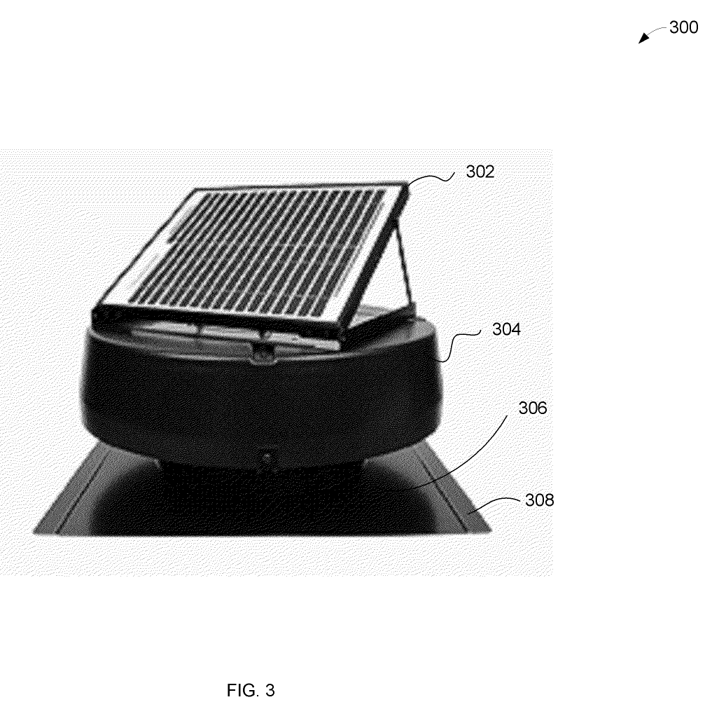

FIG. 3 illustrates, generally at 300, one embodiment of the invention showing a tiltable and rotatable solar array 302, a fan shroud 304, a base mounting 306, to a roof 308.

In one embodiment of the invention, the fan shroud is raised by the base mount (e.g. 304, 306 as in FIG. 3) above the surface mounted on (e.g. 308 roof as in FIG. 3).

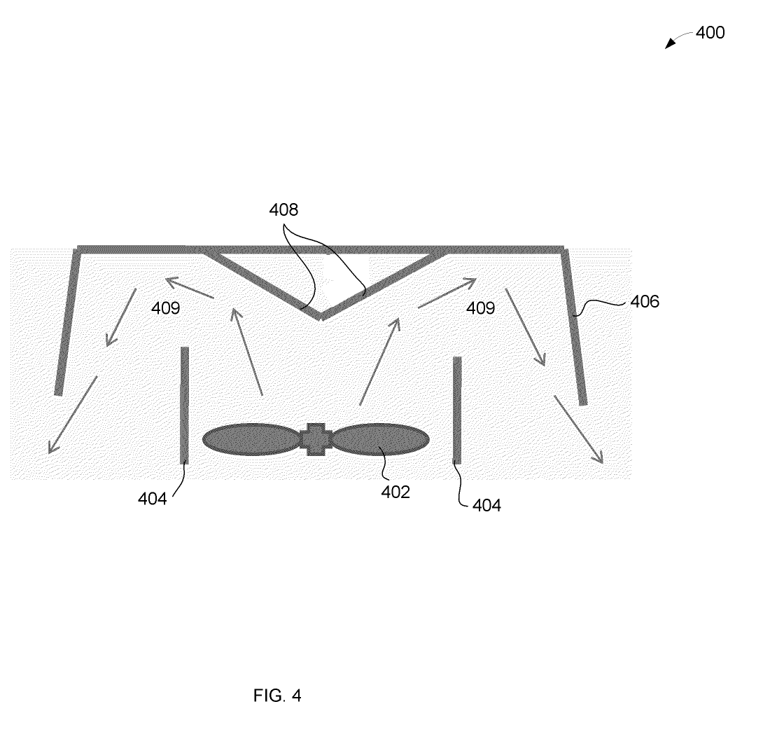

FIG. 4 illustrates, generally at 400, one embodiment of the invention showing a cross-section of a fan 402, a fan guide 404, a fan shroud 406, an air flow guide 408, and air flow 409.

In one embodiment of the invention, the air flow guide (e.g. 408 in FIG. 4) may be cone shaped.

In one embodiment of the invention, the air flow guide (e.g. 408 in FIG. 4) may be cone shaped and reduces back pressure experienced by a fan (e.g. 402 in FIG. 4). As a result of reduced back pressure the fan (e.g. 402 in FIG. 4) has increased air flow (as measured in CFM (cubic feet per minute)).

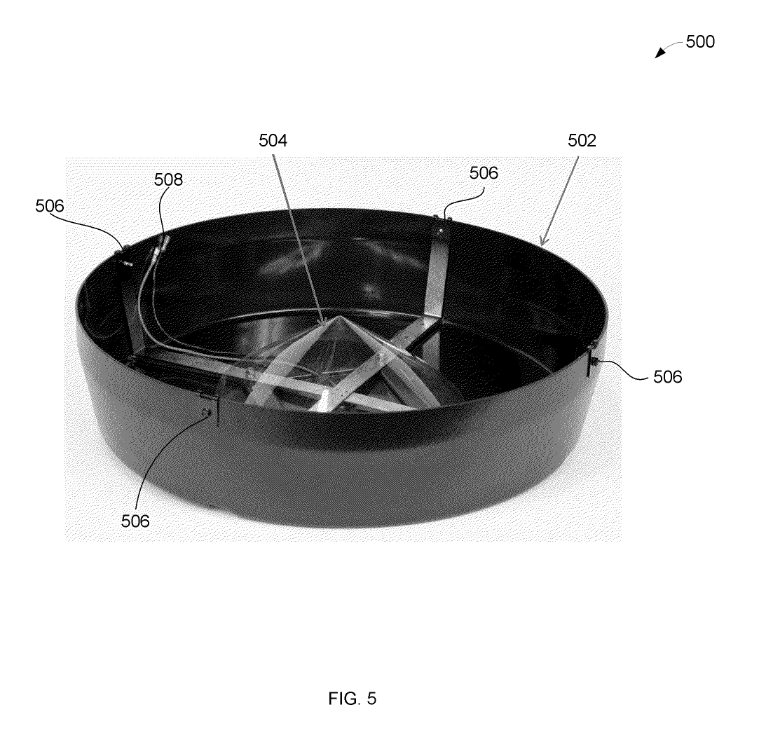

FIG. 5 illustrates, generally at 500, one embodiment of the invention showing an inner perspective view of a fan shroud 502, a cone-shaped air flow guide 504, mountings 506 for the cone-shaped air flow guide 504, and electrical wires 508 that come from a solar panel (e.g. 302 in FIG. 3) (not illustrated in FIG. 5).

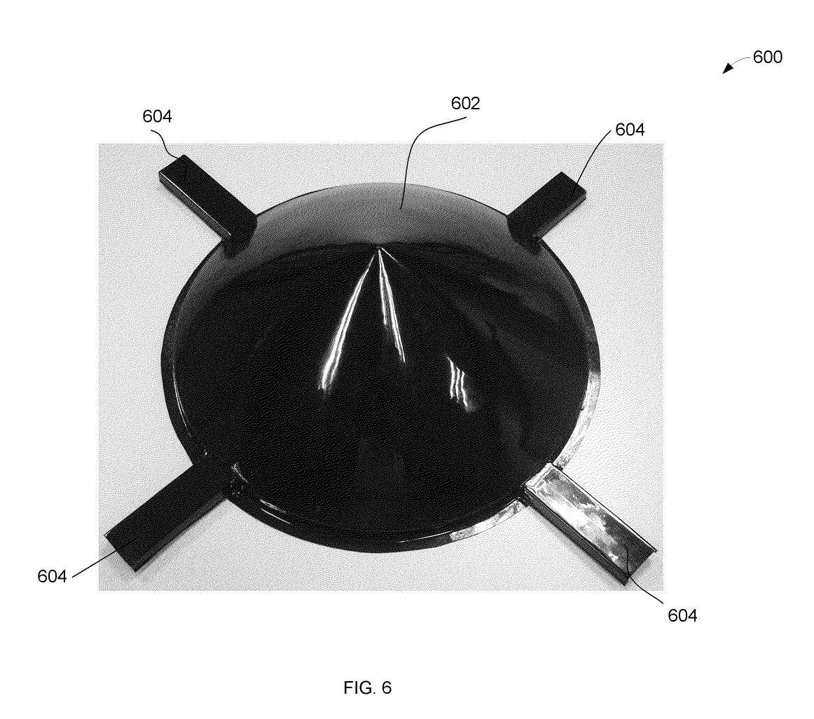

FIG. 6 illustrates, generally at 600, one embodiment of the invention showing a front close up view of an air flow guide have a cone-shaped portion 602 and mounting tabs 604.

While embodiments of the invention have been illustrated with a cone-shaped air flow guide, one of skill in the art will appreciate that other shaped sections may be used, for example, but not limited to concave/convex type cone, fluted cone, pyramid (3, 4, . . . , sides), etc. Additionally attachment points to secure the flow guide to the shroud may be other than the 4 shown above (e.g. 2, 3, 5, . . . attachment points).

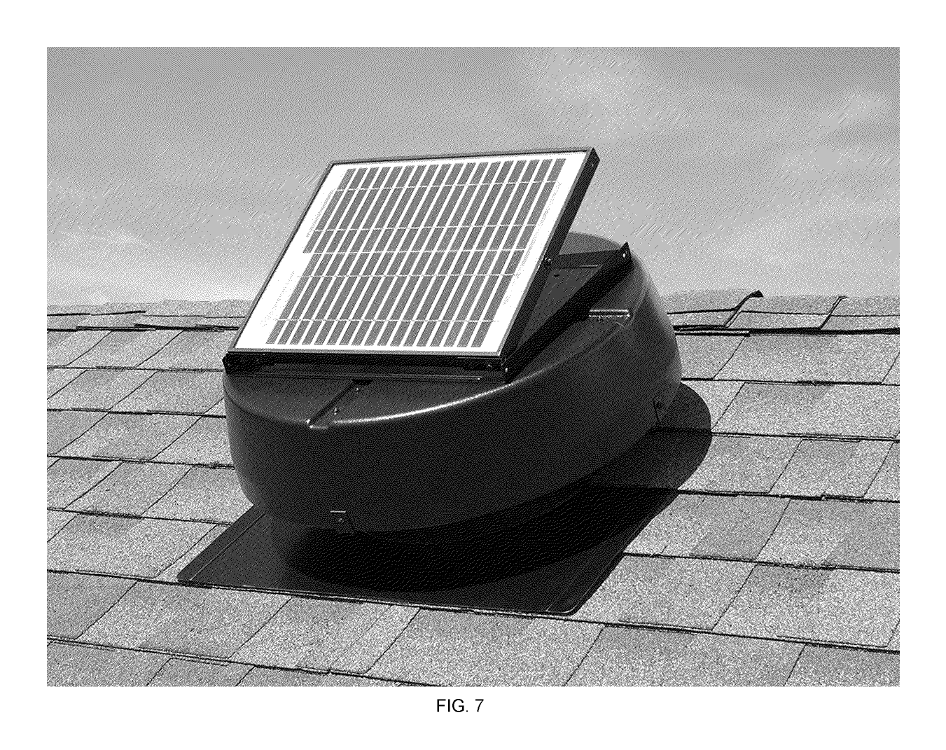

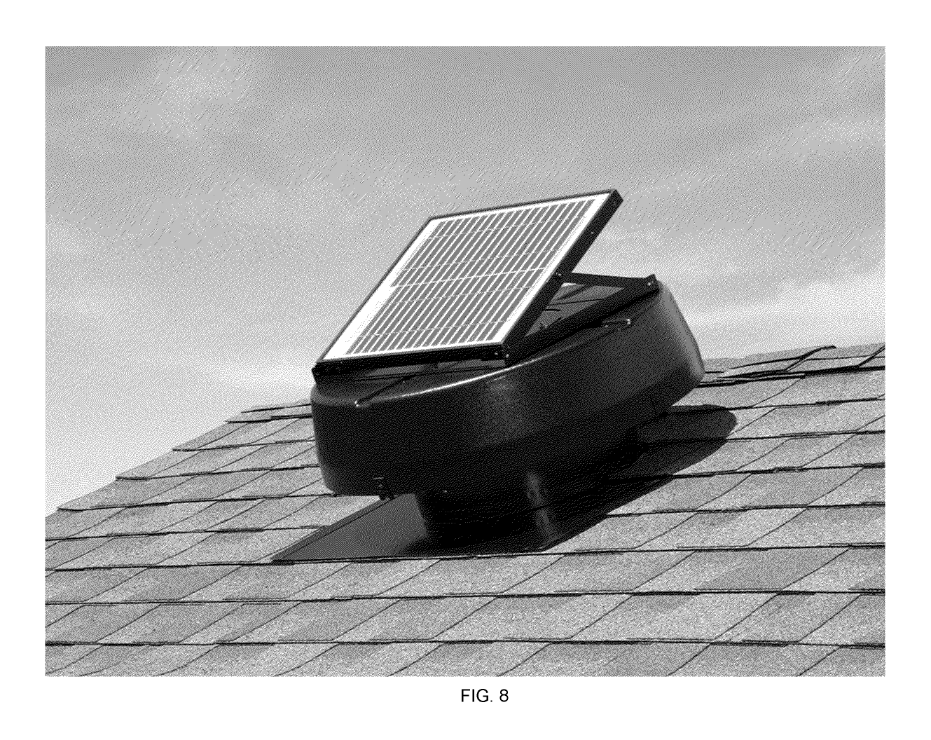

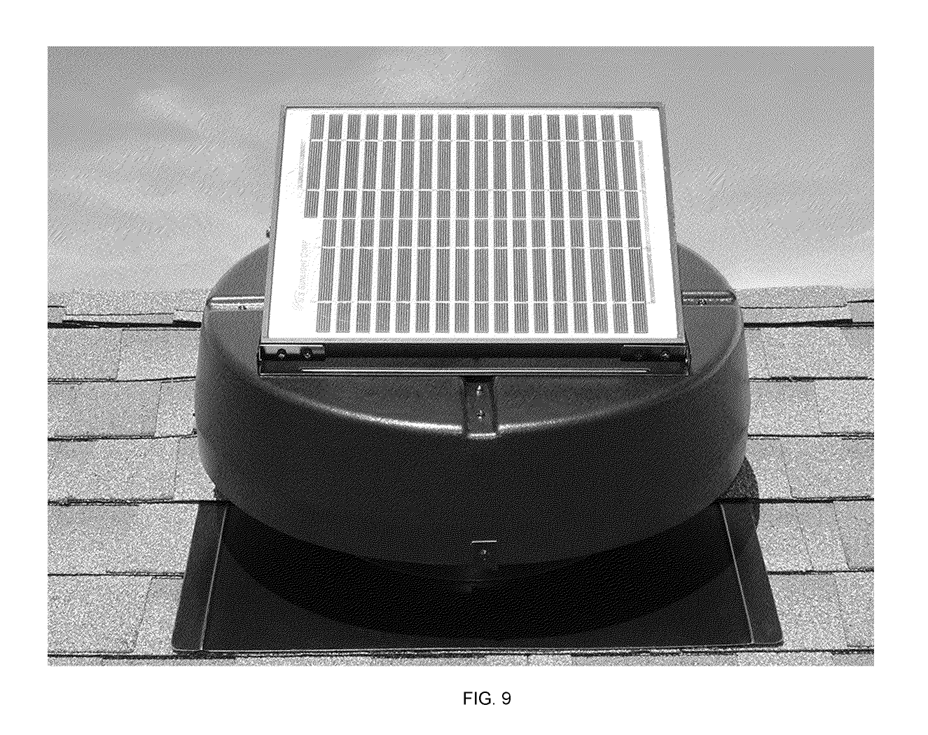

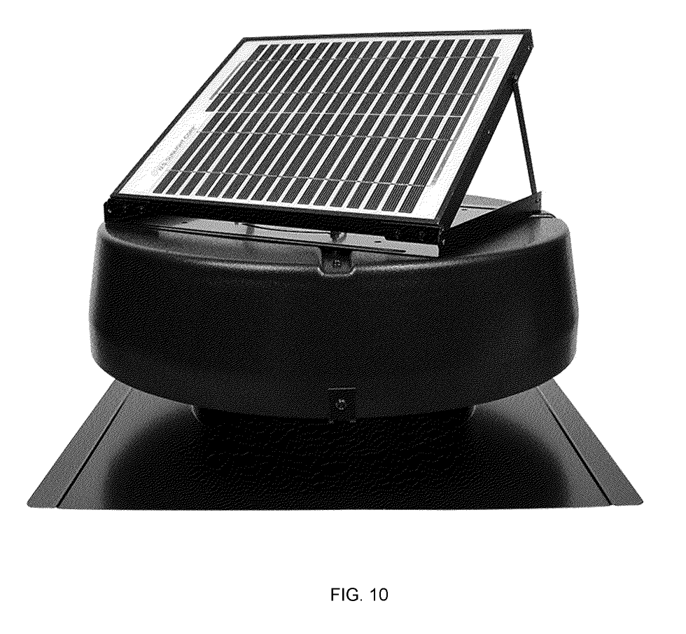

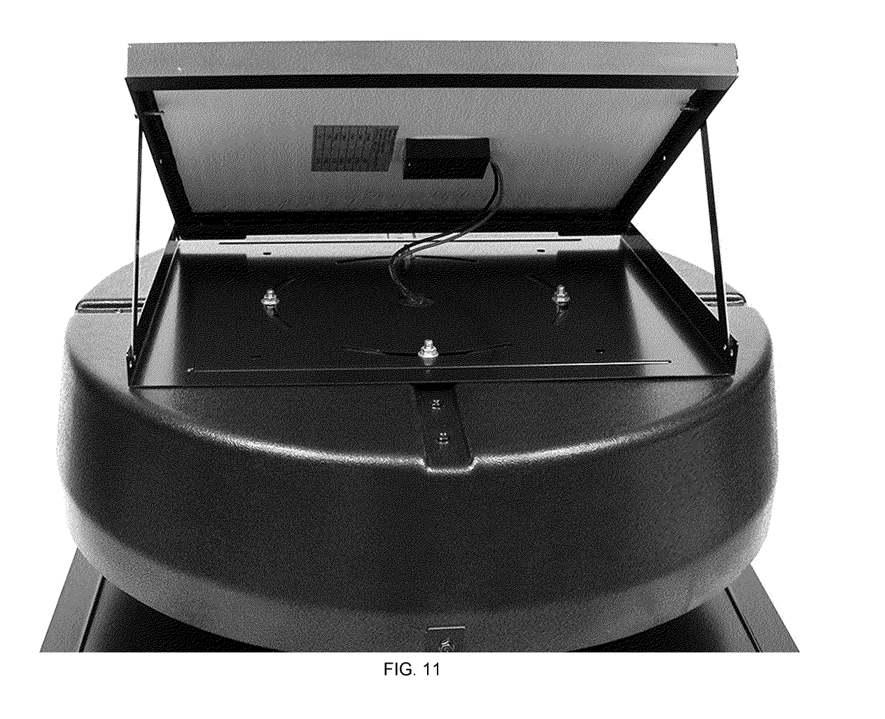

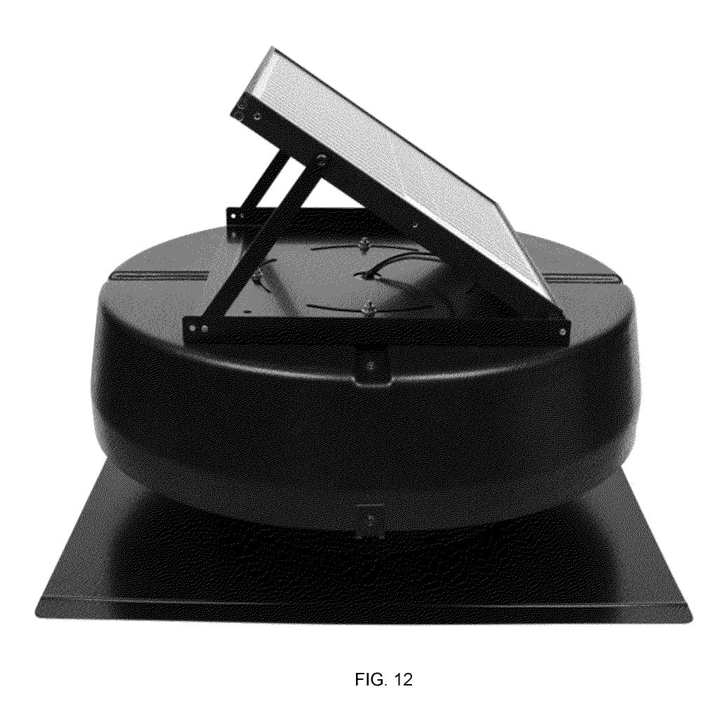

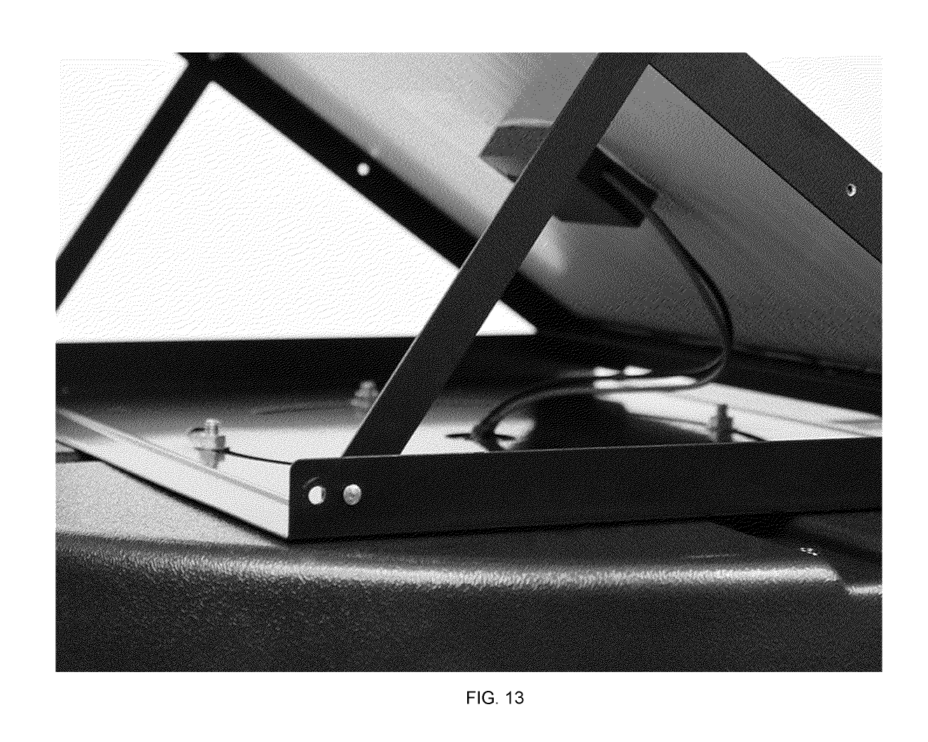

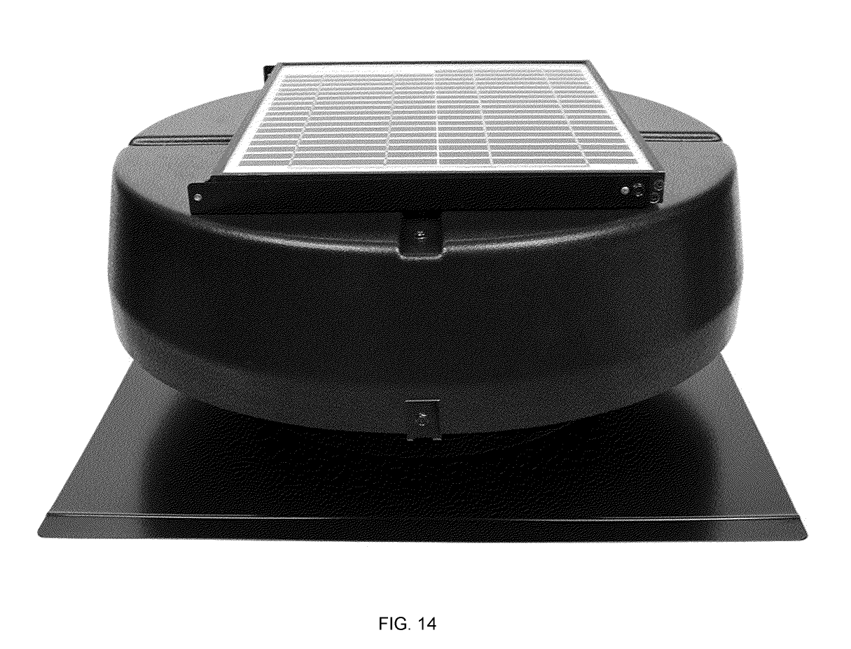

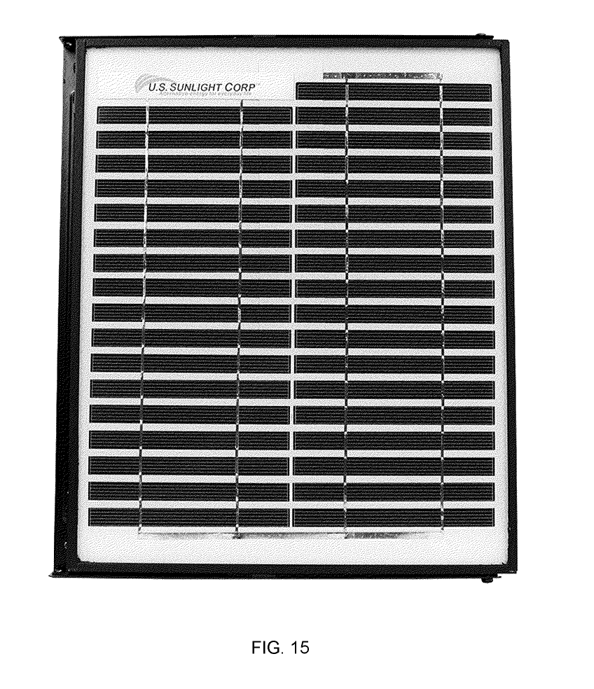

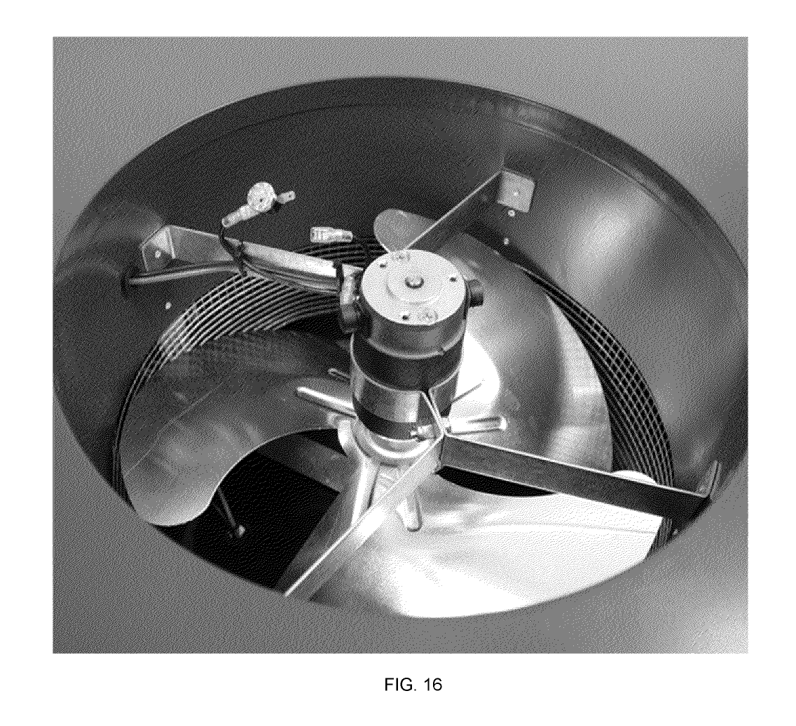

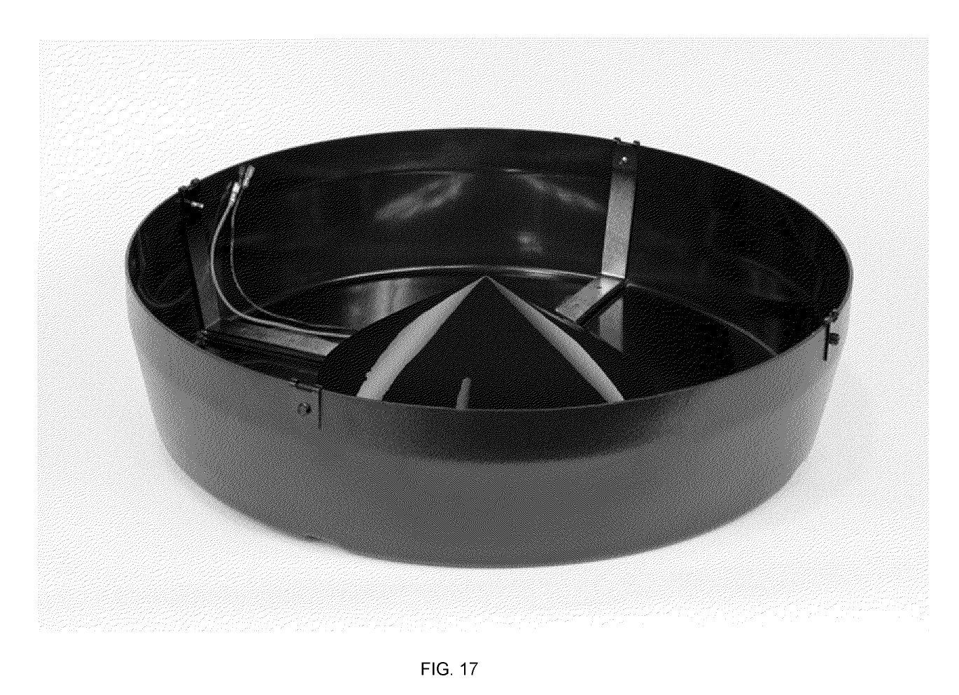

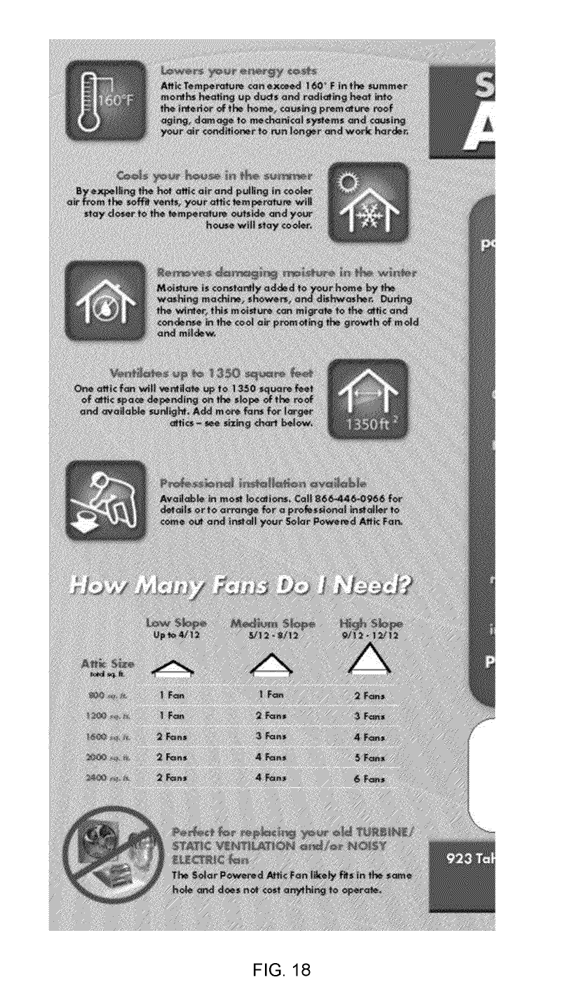

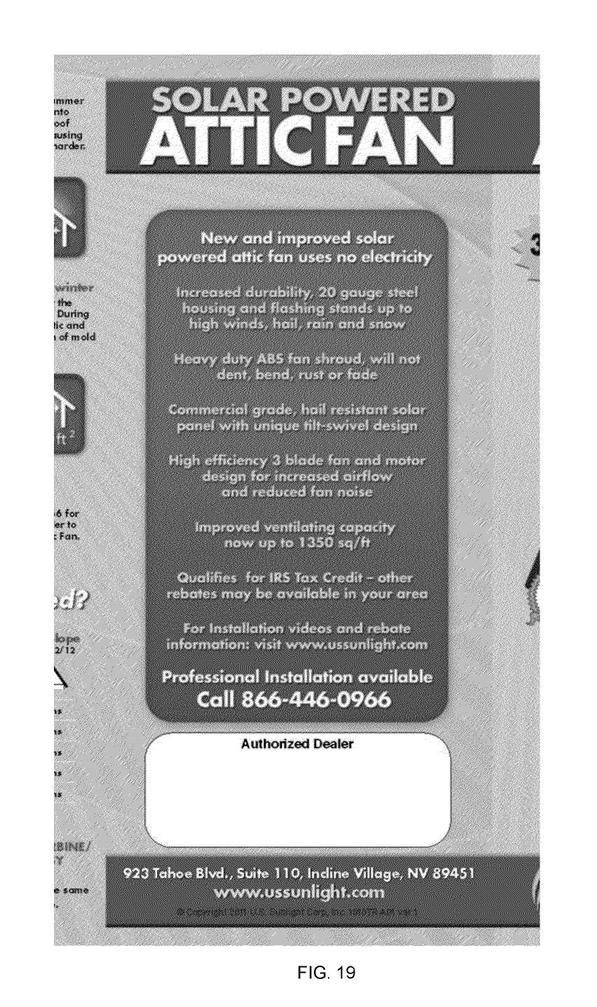

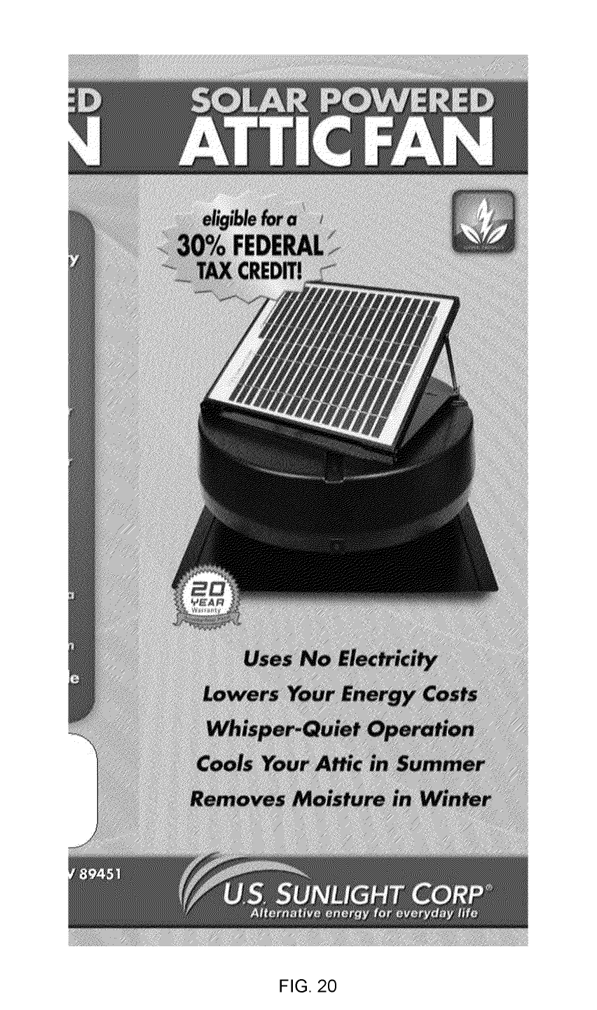

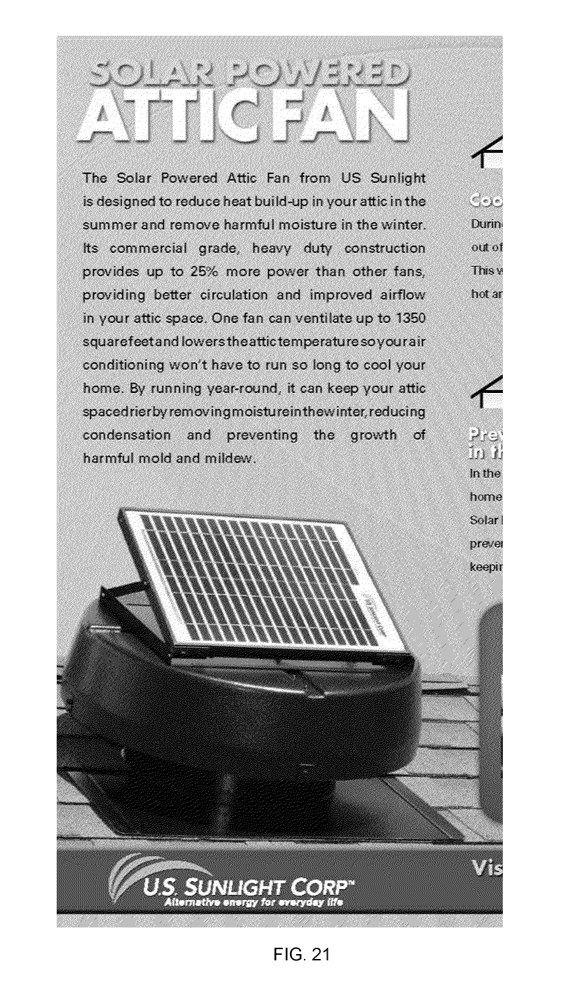

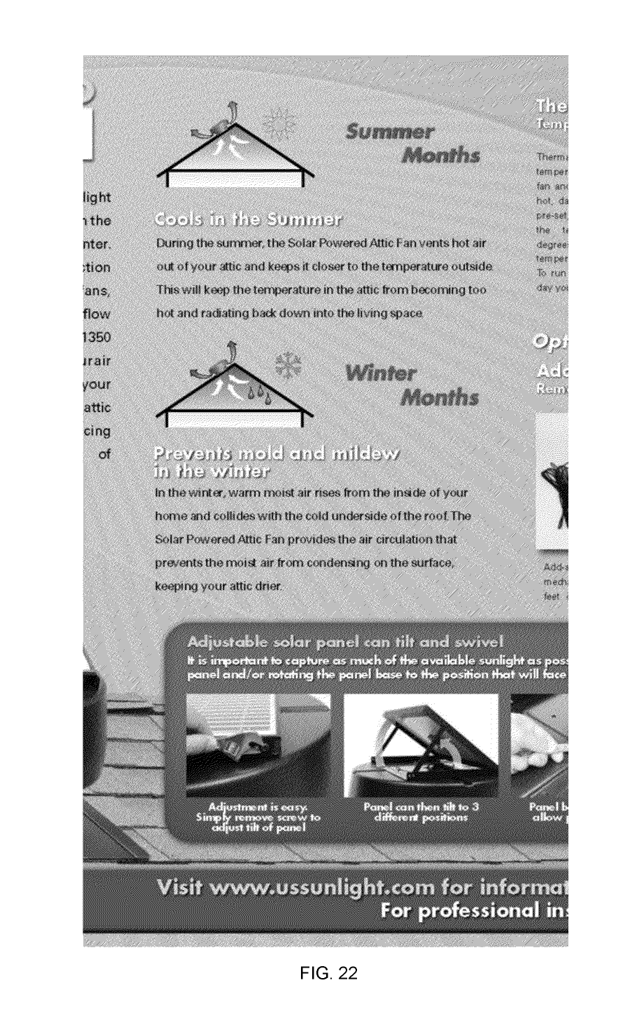

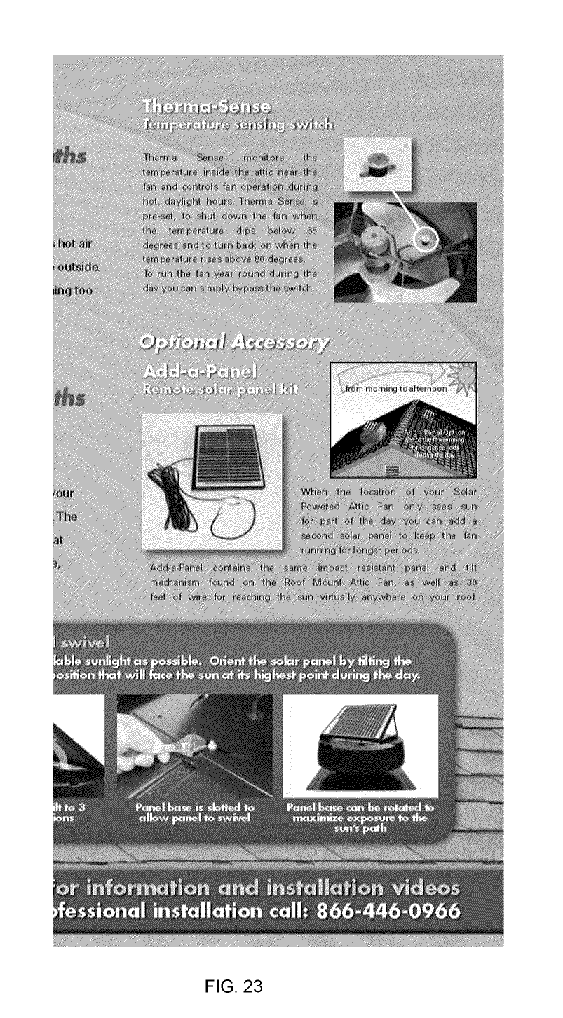

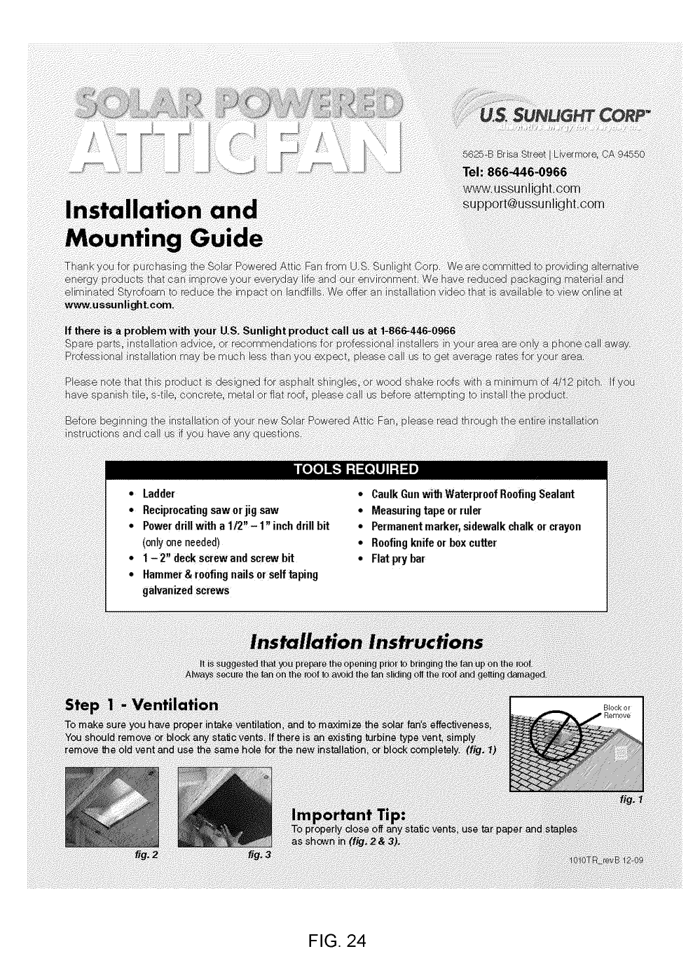

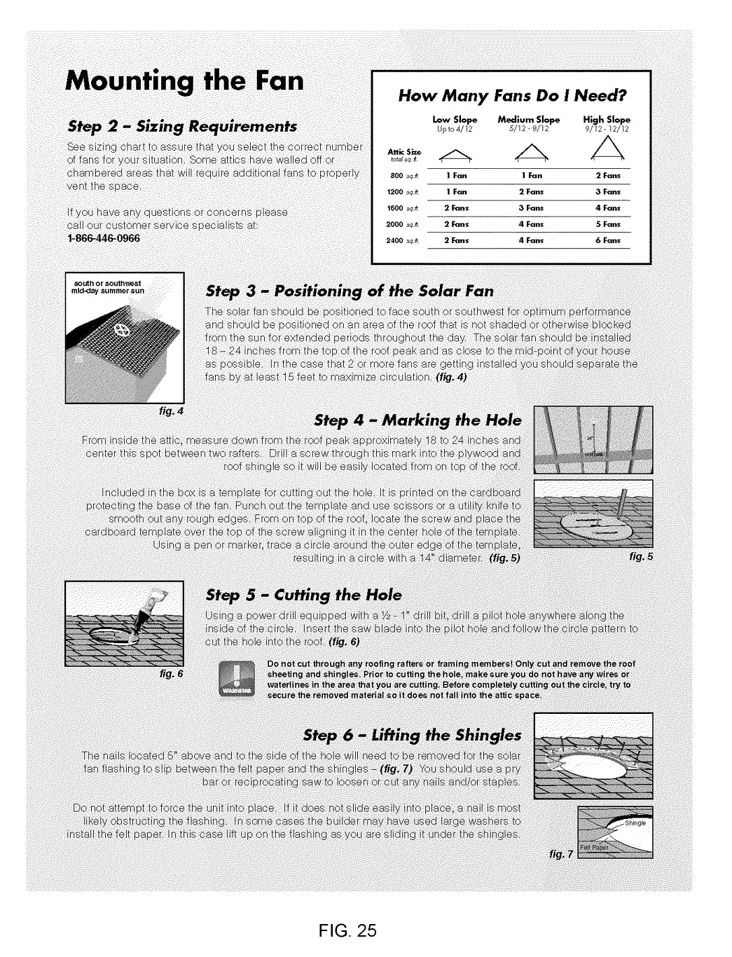

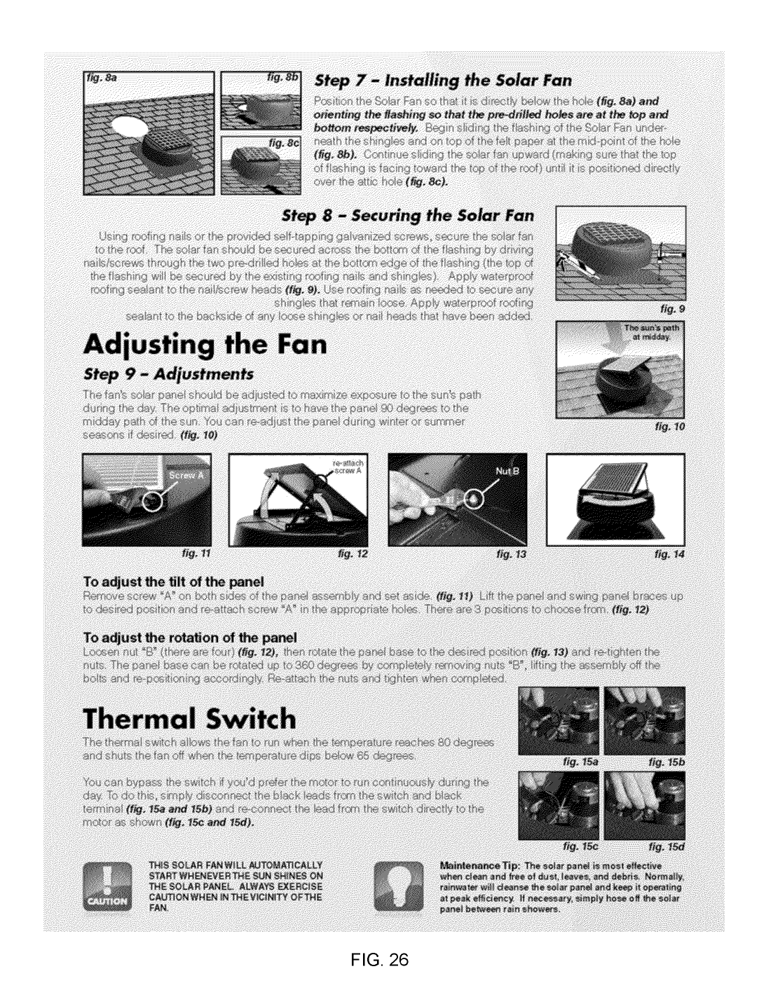

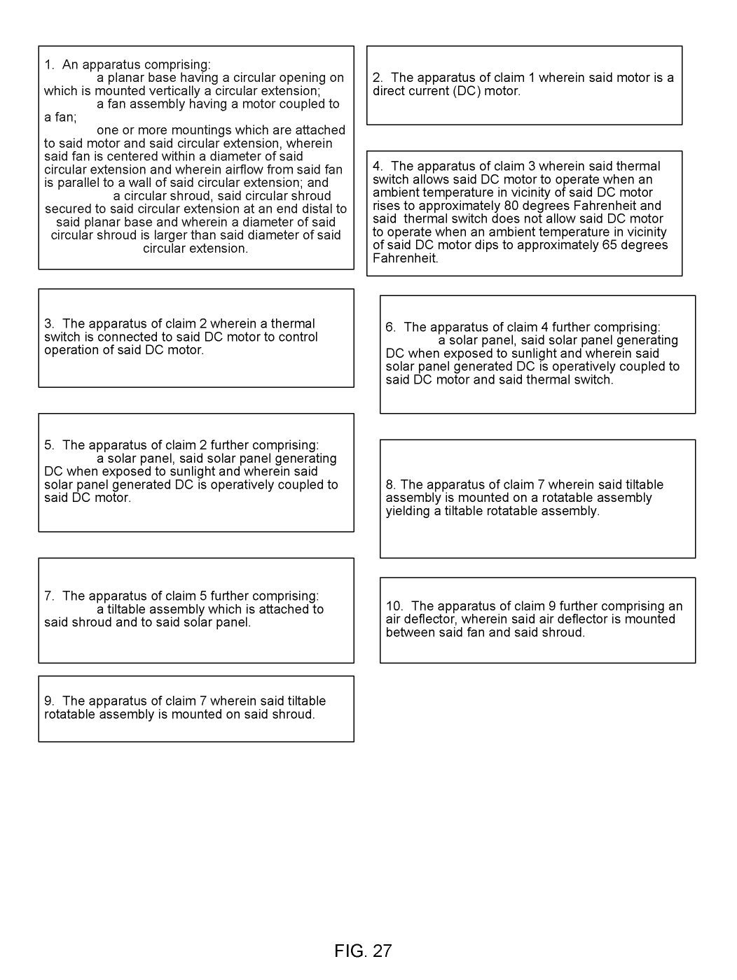

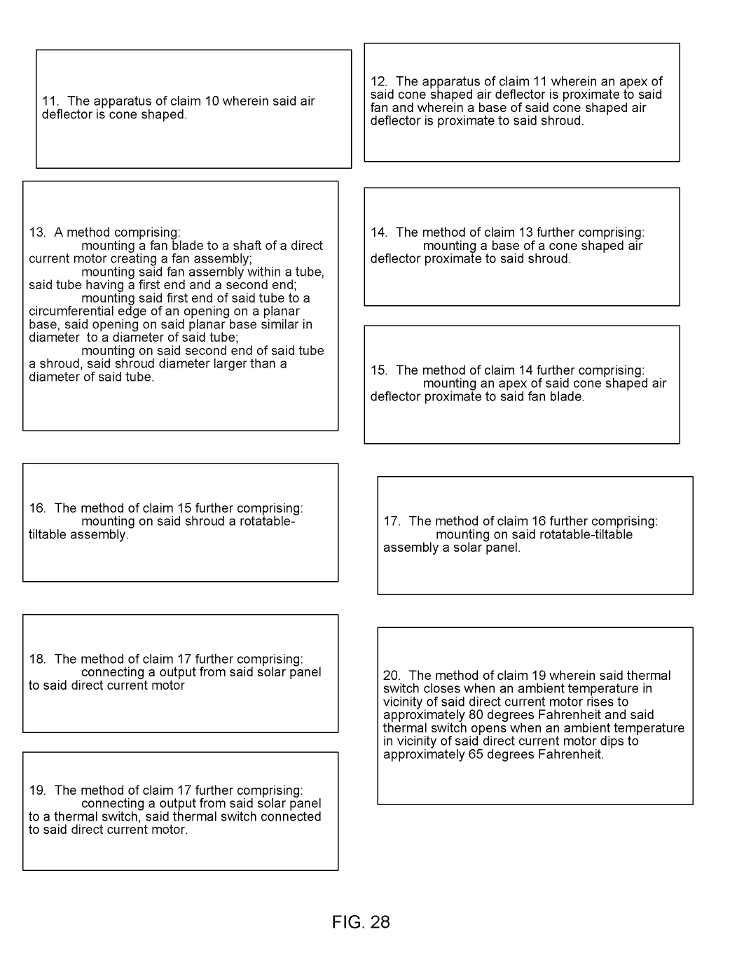

FIGS. 7 and 8 illustrate various embodiments of the invention.

In one embodiment of the invention the Solar Attic Fan uses no electricity. The Solar Attic Fan is designed to reduce heat build-up in your attic in the summer and remove harmful moisture in the winter. It's commercial grade, heavy duty construction provides up to 25% more power than other fans, providing better circulation and improved airflow in your attic space. One fan can ventilate up to 1350 square feet and can lower the attic temperature so your air conditioning won't have to run as long and as hard to cool your home. By running year-round, it can keep your attic space drier by removing moisture in the winter, reducing condensation and preventing the growth of harmful mold and mildew.

In one embodiment of the invention the fan cools in the summer. During the peak summer months, your attic's temperature can rise to 160° or more. This heat build-up can then raise the temperature inside your home and increase the amount of electricity used by air conditioners and other cooling equipment. Installing a Solar Powered Attic Fan will help remove the heat build-up in your attic and bring your attic's temperature down closer to the ambient outside temperature. The reduction in attic temperature will also benefit the homeowner by preserving and extending the life of the roofing and attic construction materials. Additionally, hot air in your attic can then heat the metal exterior of your HVAC ductwork and consequently heat the air passing through it, causing your air conditioner to work even harder.

In one embodiment of the invention the fan prevents mold and mildew in the winter. In the winter, warm moist air rises from the inside of your home and collides with the cold underside of the roof. The Solar Powered Attic Fan provides the air circulation that prevents the moist air from condensing on the surface. Keeping your attic drier and helping to prevent mold and mildew inside your attic and ice damming on your roof.

In one embodiment of the invention:

Materials of Construction

| | |
|---|---|
| Shroud Cover | Vacuformed Qi-Mei 747S ABS with Ultraviolet Light inhibitors, 0.5 mm |
| | thickness Resists fading, denting, rusting, and cracking |
| Flashing/Housing | 20 gauge steel |
| Rodent Screen | ¼″ stainless steel mesh screen secured with galvanized self-taping screws |
| Fan Blade | 14″ 3-wing ultra quiet aluminum blades with pitch angle matched to dc |
| | motor/solar panel |
| Finish | Metal components are steel finished with zinc alloy G-90 thickness, hot dipped. |
| | Painted metal components are powder coated: pure polyester coating 3-5 mils |
| | thickness |
| Solar Panel | 10 Watt panel with high transmission tempered glass encapsulating 35 mono- |
| | crystalline solar cells. Manufactured to ISO 9001 standards |
| Motor | 38 volt DC motor with external brushes |
| Wiring | 16 gauge black and red copper wire |
| Unit dimensions | 24″ × 24″ × 10.5″, 23.65 lbs |

In one embodiment of the invention you can Lower your energy costs. Attic temperatures can exceed 160° F. in the summer months heating up air-condition ducting and radiating heat into your home. This forces your air conditioning to work harder.

In one embodiment of the invention there is an Adjustable Solar Panel. It is important to capture as much of the available sunlight as possible. Orient the solar panel by tilting and/or swiveling the panel assembly to the position that will face the sun at it's highest point during the day.

In one embodiment of the invention it Ventilates up to 1350 sq/ft. One attic fan will ventilate up to 1350 square feet of attic space depending on the slope of the roof and available sunlight. Add more fans for larger attics.

In one embodiment of the invention it Removes Damaging Moisture. In the winter, moisture is constantly added to your home by the washing machine, showers, and dishwasher. During the winter, this moisture can migrate to the attic and condense in the cool air promoting the growth of mold and mildew.

In one embodiment of the invention it Cools Your House In The Summer. By expelling the hot attic air and pulling in cooler air from the soffit vents, your house will stay cooler.

In one embodiment of the invention it has Oversized Flashing. Oversized flashing is made of a heavy gauge steel and has been designed for leak-proof installation. The attractive black powder coating blends in with any roof color.

In one embodiment of the invention there are cost benefits of installing a solar attic fan. How much money you will save is greatly dependent on the price of electricity in your area, the amount of attic space in your home, the efficiency of your attic insulation, the amount of tax credit and rebates available in your area and the amount of ventilation your solar attic vent is able to provide. In our experience, a typical installation will usually pay for itself within 1-3 summers of use verses powered Attic Fans that can cost up to $35 per month to operate.

In one embodiment of the invention even existing roof ventilation is assisted. Static vents or ridge vents will help but generally do not provide sufficient air movement to pull heat and moisture from the attic—especially during the winter or when the ambient air is stagnate. If you have electric fans in the attic, you will benefit from increased air movement in the summer but at a cost of 350 to 400 watts of power per day! Often, electric attic fans have a thermostat that keeps them inoperable during the winter, just when you need them to expel moisture! A solar powered attic fan runs whenever there is sunlight—and, at no cost of operation.

In one embodiment of the invention the solar powered attic fan is extremely quiet. The solar cell provides power to a super-quiet DC motor. There is no harmonic hum that is common with AC motors.

In one embodiment of the invention the Solar Powered Attic Fan has the latest state-of-the-art solar panel designed to last for more than 20 years. While a standard solar panel can last 5 years or less, our solar panel has a 20 year prorated warranty—the longest warranty in the industry!

In one embodiment of the invention the Solar Powered Attic Fan includes a commercial grade, hail resistant solar panel with a unique tilt-swivel design. By maximizing the solar panel's orientation to the sun you can gain up to 25% more power. In addition, our top of line motor has been designed with a simple brush replacement feature, assuring many years of worry-free performance.

In one embodiment of the invention it ventilates up to 1900 square feet. A Professional grade, 15 Watt solar panel with heavy duty ABS fan shroud and 20 gauge steel housing and flashing. Includes a smooth air deflection cone. Cools your home in the summer and removes harmful moisture in the winter.

Thus a method and apparatus for solar attic fan with air flow guide have been described.

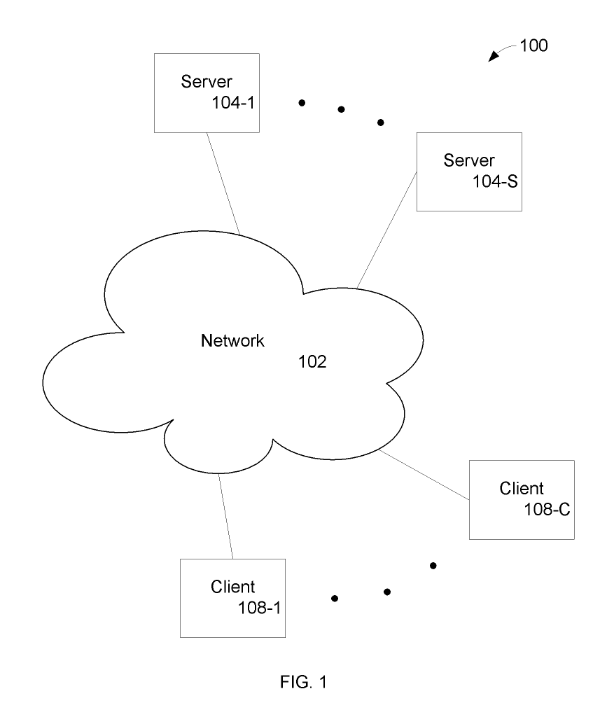

FIG. 1 illustrates a network environment 100 from which the techniques described may be controlled. The network environment 100 has a network 102 that connects S servers 104-1 through 104-S, and C clients 108-1 through 108-C. More details are described below.

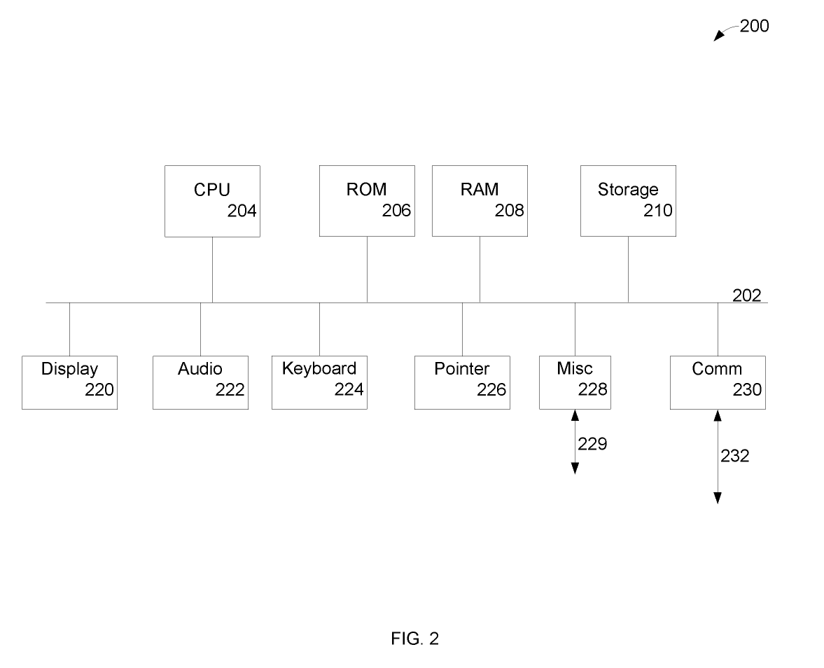

FIG. 2 is a block diagram of a computer system 200 which some embodiments of the invention may employ parts of and which may be representative of use in any of the clients and/or servers shown in FIG. 1, as well as, devices, clients, and servers in other Figures. More details are described below.

Referring back to FIG. 1, FIG. 1 illustrates a network environment 100 in which the techniques described may be controlled. The network environment 100 has a network 102 that connects S servers 104-1 through 104-S, and C clients 108-1 through 108-C. As shown, several computer systems in the form of S servers 104-1 through 104-S and C clients 108-1 through 108-C are connected to each other via a network 102, which may be, for example, a corporate based network. Note that alternatively the network 102 might be or include one or more of: the Internet, a Local Area Network (LAN), Wide Area Network (WAN), satellite link, fiber network, cable network, or a combination of these and/or others. The servers may represent, for example, disk storage systems alone or storage and computing resources. Likewise, the clients may have computing, storage, and viewing capabilities. The method and apparatus described herein may be controlled by essentially any type of communicating means or device whether local or remote, such as a LAN, a WAN, a system bus, etc. For example, a network connection which communicates via for example wireless may control an embodiment of the invention having a wireless communications device. Thus, the invention may find application at both the S servers 104-1 through 104-S, and C clients 108-1 through 108-C.

Referring back to FIG. 2, FIG. 2 illustrates a computer system 200 in block diagram form, which may be representative of any of the clients and/or servers shown in FIG. 1. The block diagram is a high level conceptual representation and may be implemented in a variety of ways and by various architectures. Bus system 202 interconnects a Central Processing Unit (CPU) 204, Read Only Memory (ROM) 206, Random Access Memory (RAM) 208, storage 210, display 220, audio, 222, keyboard 224, pointer 226, miscellaneous input/output (I/O) devices 228 via link 229, and communications 230 via port 232. The bus system 202 may be for example, one or more of such buses as a system bus, Peripheral Component Interconnect (PCI), Advanced Graphics Port (AGP), Small Computer System Interface (SCSI), Institute of Electrical and Electronics Engineers (IEEE) standard number 1394 (FireWire), Universal Serial Bus (USB), etc. The CPU 204 may be a single, multiple, or even a distributed computing resource. Storage 210, may be Compact Disc (CD), Digital Versatile Disk (DVD), hard disks (HD), optical disks, tape, flash, memory sticks, video recorders, etc. Display 220 might be, for example, an embodiment of the present invention. Note that depending upon the actual implementation of a computer system, the computer system may include some, all, more, or a rearrangement of components in the block diagram. For example, a thin client might consist of a wireless hand held device that lacks, for example, a traditional keyboard. Thus, many variations on the system of FIG. 2 are possible.

For purposes of discussing and understanding the invention, it is to be understood that various terms are used by those knowledgeable in the art to describe techniques and approaches. Furthermore, in the description, for purposes of explanation, numerous specific details are set forth in order to provide a thorough understanding of the present invention. It will be evident, however, to one of ordinary skill in the art that the present invention may be practiced without these specific details. In some instances, well-known structures and devices are shown in block diagram form, rather than in detail, in order to avoid obscuring the present invention. These embodiments are described in sufficient detail to enable those of ordinary skill in the art to practice the invention, and it is to be understood that other embodiments may be utilized and that logical, mechanical, electrical, and other changes may be made without departing from the scope of the present invention.

Some portions of the description may be presented in terms of algorithms and symbolic representations of operations on, for example, data bits within a computer memory. These algorithmic descriptions and representations are the means used by those of ordinary skill in the data processing arts to most effectively convey the substance of their work to others of ordinary skill in the art. An algorithm is here, and generally, conceived to be a self-consistent sequence of acts leading to a desired result. The acts are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion, it is appreciated that throughout the description, discussions utilizing terms such as “processing” or “computing” or “calculating” or “determining” or “displaying” or the like, can refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

An apparatus for performing the operations herein can implement the present invention. This apparatus may be specially constructed for the required purposes, or it may comprise a general-purpose computer, selectively activated or reconfigured by a computer program stored in the computer. Such a computer program may be stored in a non-transitory computer readable storage medium, such as, but not limited to, any type of disk including floppy disks, hard disks, optical disks, compact disk-read only memories (CD-ROMs), and magnetic-optical disks, read-only memories (ROMs), random access memories (RAMs), electrically programmable read-only memories (EPROM)s, electrically erasable programmable read-only memories (EEPROMs), FLASH memories, magnetic or optical cards, etc., or any type of non-transitory media suitable for storing electronic instructions either local to the computer or remote to the computer.

The algorithms and displays presented herein are not inherently related to any particular computer or other apparatus. Various general-purpose systems may be used with programs in accordance with the teachings herein, or it may prove convenient to construct more specialized apparatus to perform the required method. For example, any of the methods according to the present invention can be implemented in hard-wired circuitry, by programming a general-purpose processor, or by any combination of hardware and software. One of ordinary skill in the art will immediately appreciate that the invention can be practiced with computer system configurations other than those described, including hand-held devices, multiprocessor systems, microprocessor-based or programmable consumer electronics, digital signal processing (DSP) devices, set top boxes, network PCs, minicomputers, mainframe computers, and the like. The invention can also be practiced in distributed computing environments where tasks are performed by remote processing devices that are linked through a communications network.

The methods of the invention may be implemented using computer software. If written in a programming language conforming to a recognized standard, sequences of instructions designed to implement the methods can be compiled for execution on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, application, driver, . . . ), as taking an action or causing a result. Such expressions are merely a shorthand way of saying that execution of the software by a computer causes the processor of the computer to perform an action or produce a result.

It is to be understood that various terms and techniques are used by those knowledgeable in the art to describe communications, protocols, applications, implementations, mechanisms, etc. One such technique is the description of an implementation of a technique in terms of an algorithm or mathematical expression. That is, while the technique may be, for example, implemented as executing code on a computer, the expression of that technique may be more aptly and succinctly conveyed and communicated as a formula, algorithm, or mathematical expression. Thus, one of ordinary skill in the art would recognize a block denoting A+B=C as an additive function whose implementation in hardware and/or software would take two inputs (A and B) and produce a summation output (C). Thus, the use of formula, algorithm, or mathematical expression as descriptions is to be understood as having a physical embodiment in at least hardware and/or software (such as a computer system in which the techniques of the present invention may be practiced as well as implemented as an embodiment).

A machine-readable medium is understood to include any non-transitory mechanism for storing or transmitting information in a form readable by a machine (e.g., a computer). For example, a non-transitory machine-readable medium includes read only memory (ROM); random access memory (RAM); magnetic disk storage media; optical storage media; flash memory devices; devices having non-transitory storage.

As used in this description, “one embodiment” or “an embodiment” or similar phrases means that the feature(s) being described are included in at least one embodiment of the invention. References to “one embodiment” in this description do not necessarily refer to the same embodiment; however, neither are such embodiments mutually exclusive. Nor does “one embodiment” imply that there is but a single embodiment of the invention. For example, a feature, structure, act, etc. described in “one embodiment” may also be included in other embodiments. Thus, the invention may include a variety of combinations and/or integrations of the embodiments described herein.

As used in this description, “substantially” or “substantially equal” or similar phrases are used to indicate that the items are very close or similar. Since two physical entities can never be exactly equal, a phrase such as “substantially equal” is used to indicate that they are for all practical purposes equal.

It is to be understood that in any one or more embodiments of the invention where alternative approaches or techniques are discussed that any and all such combinations as my be possible are hereby disclosed. For example, if there are five techniques discussed that are all possible, then denoting each technique as follows: A, B, C, D, E, each technique may be either present or not present with every other technique, thus yielding 2̂5 or 32 combinations, in binary order ranging from not A and not B and not C and not D and not E to A and B and C and D and E. Applicant(s) hereby claims all such possible combinations. Applicant(s) hereby submit that the foregoing combinations comply with applicable EP (European Patent) standards. No preference is given any combination.

Thus a method and apparatus for solar attic fan with air flow guide have been described.

What is claimed is:

1. An apparatus comprising:
a planar base having a circular opening on which is mounted vertically a circular extension;
a fan assembly having a motor coupled to a fan;
one or more mountings which are attached to said motor and said circular extension, wherein said fan is centered within a diameter of said circular extension and wherein airflow from said fan is parallel to a wall of said circular extension; and
a circular shroud, said circular shroud secured to said circular extension at an end distal to said planar base and wherein a diameter of said circular shroud is larger than said diameter of said circular extension.

2. The apparatus of claim 1 wherein said motor is a direct current (DC) motor.

3. The apparatus of claim 2 wherein a thermal switch is connected to said DC motor to control operation of said DC motor.

4. The apparatus of claim 3 wherein said thermal switch allows said DC motor to operate when an ambient temperature in vicinity of said DC motor rises to approximately 80 degrees Fahrenheit and said thermal switch does not allow said DC motor to operate when an ambient temperature in vicinity of said DC motor dips to approximately 65 degrees Fahrenheit.

5. The apparatus of claim 2 further comprising:
a solar panel, said solar panel generating DC when exposed to sunlight and wherein said solar panel generated DC is operatively coupled to said DC motor.

6. The apparatus of claim 4 further comprising:
a solar panel, said solar panel generating DC when exposed to sunlight and wherein said solar panel generated DC is operatively coupled to said DC motor and said thermal switch.

7. The apparatus of claim 5 further comprising:
a tiltable assembly which is attached to said shroud and to said solar panel.

8. The apparatus of claim 7 wherein said tiltable assembly is mounted on a rotatable assembly yielding a tiltable rotatable assembly.

9. The apparatus of claim 7 wherein said tiltable rotatable assembly is mounted on said shroud.

10. The apparatus of claim 9 further comprising an air flow guide, wherein said air flow guide is mounted between said fan and said shroud.

11. The apparatus of claim 10 wherein said air flow guide is cone shaped.

12. The apparatus of claim 11 wherein an apex of said cone shaped air flow guide is proximate to said fan and wherein a base of said cone shaped air flow guide is proximate to said shroud.

13. A method comprising:
mounting a fan blade to a shaft of a direct current motor creating a fan assembly;
mounting said fan assembly within a tube, said tube having a first end and a second end;
mounting said first end of said tube to a circumferential edge of an opening on a planar base, said opening on said planar base similar in diameter to a diameter of said tube;
mounting on said second end of said tube a shroud, said shroud diameter larger than a diameter of said tube.

14. The method of claim 13 further comprising:
mounting a base of a cone shaped air flow guide proximate to said shroud.

15. The method of claim 14 further comprising:
mounting an apex of said cone shaped air flow guide proximate to said fan blade.

16. The method of claim 15 further comprising:
mounting on said shroud a rotatable-tiltable assembly.

17. The method of claim 16 further comprising:
mounting on said rotatable-tiltable assembly a solar panel.

18. The method of claim 17 further comprising:
connecting a output from said solar panel to said direct current motor

19. The method of claim 17 further comprising:
connecting a output from said solar panel to a thermal switch, said thermal switch connected to said direct current motor.

20. The method of claim 19 wherein said thermal switch closes when an ambient temperature in vicinity of said direct current motor rises to approximately 80 degrees Fahrenheit and said thermal switch opens when an ambient temperature in vicinity of said direct current motor dips to approximately 65 degrees Fahrenheit.
